(19) United States
(12) Patent Application Publication
(10) Pub. No.: US 2012/0125861 A1
(43) Pub. Date: May 24, 2012

(54) METHOD AND SYSTEM FOR REDUCTION OF SCALING IN PURIFICATION OF AQUEOUS SOLUTIONS

(75) Inventor: Eugene Thiers, San Mateo, CA (US)

(73) Assignee: Sylvan Source, Inc., San Carlos, CA (US)

(21) Appl. No.: 13/263,797

(22) PCT Filed: Apr. 12, 2010
(86) PCT No.: PCT/US10/30759

§ 371 Date: Jan. 3, 2012

Related U.S. Application Data
(60) Provisional application No. 61/168,501, filed on Apr. 10, 2009.

(51) Int. Cl. C02F 5/02; C01F 5/24; C01F 11/18; C02F 1/52; C01B 31/24

(52) U.S. Cl. 210/718; 210/724; 210/199; 423/419.1; 423/430

(57) ABSTRACT

A method for removing hydrocarbons and scale forming compounds from tap water, contaminated aqueous solutions, seawater, and saline brines, such as produce water, comprising the addition of carbonate ions by CO₂ sparging, or divalent cations, so as precipitate calcium and magnesium carbonates by adjusting pH to about 10.2, thus permanently sequestering CO₂ from the atmosphere, and then removing such precipitates sequentially for either sale of disposal.

### FIELD OF THE INVENTION

This invention relates to the field of water purification. In particular, embodiments of the invention relate to systems and methods of removing essentially all of a broad spectrum of hydrocarbons and scale forming ions from contaminated water and from saline aqueous solutions, such as seawater and produce water, in an automated process that requires minimal cleaning or user intervention and that, when dealing with seawater or highly saline brines, provides for permanent sequestration of carbon dioxide from the atmosphere.

### BACKGROUND

Water purification technology is rapidly becoming an essential aspect of modern life as conventional water resources become increasingly scarce, municipal distribution systems for potable water deteriorate with age, and increased water usage depletes wells and reservoirs, causing saline water contamination. However, water purification technologies often are hindered in their performance by hydrocarbons and scale formation and subsequent fouling of either heat exchangers or membranes. Other household appliances, such as water heaters and washing machines are equally affected by scale whenever hard-water is used, and industrial processes are also subject to scaling of surfaces that are in contact with hot aqueous solutions. Scaling up problems and hydrocarbons are particularly important in industrial desalination plants and in the treatment of produce water from oil and gas extraction operations. There is a need for methods that eliminate both hydrocarbons and scale-forming ions from aqueous solutions.

Water hardness is normally defined as the amount of calcium (Ca⁺⁺), magnesium (Mg⁺⁺), and other divalent ions that are present in the water, and is normally expressed in parts per million (ppm) of these ions or their equivalent as calcium carbonate (CaCO₃). Scale forms because the water dissolves carbon dioxide from the atmosphere and such carbon dioxide provides carbonate ions that combine to form both, calcium and magnesium carbonates; upon heating, the solubility of calcium and magnesium carbonates markedly decreases and they precipitate as scale. In reality, scale comprises any chemical compound that precipitates from solution. Thus iron phosphates or calcium sulfate (gypsum) also produce scale. Table 1 lists a number of chemical compounds that exhibit low solubility in water and, thus, that can form scale; low solubility is defined here by the solubility product, that is, by the product of the ionic concentration of cations and anions of a particular chemical; in turn, solubility is usually expressed in moles per liter (mol/l).

TABLE 1
Solubility Products of Various Compounds

| Compound | Formula | Kₛₚ (25° C.) |
|---|---|---|
| Aluminum hydroxide | Al(OH)₃ | 3 × 10⁻³⁴ |
| Aluminum phosphate | AlPO₄ | 9.84 × 10⁻²¹ |
| Barium bromate | Ba(BrO₃)₂ | 2.43 × 10⁻⁴ |
| Barium carbonate | BaCO₃ | 2.58 × 10⁻⁹ |
| Barium chromate | BaCrO₄ | 1.17 × 10⁻¹⁰ |
| Barium fluoride | BaF₂ | 1.84 × 10⁻⁷ |
| Barium hydroxide octahydrate | Ba(OH)₂×8H₂O | 2.55 × 10⁻⁴ |
| Barium iodate | Ba(IO₃)₂ | 4.01 × 10⁻⁹ |
| Barium iodate monohydrate | Ba(IO₃)₂×H₂O | 1.67 × 10⁻⁹ |
| Barium molybdate | BaMoO₄ | 3.54 × 10⁻⁸ |
| Barium nitrate | Ba(NO₃)₂ | 4.64 × 10⁻³ |
| Barium selenate | BaSeO₄ | 3.40 × 10⁻⁸ |
| Barium sulfate | BaSO₄ | 1.08 × 10⁻¹⁰ |
| Barium sulfite | BaSO₃ | 5.0 × 10⁻¹⁰ |
| Beryllium hydroxide | Be(OH)₂ | 6.92 × 10⁻²² |
| Bismuth arsenate | BiAsO₄ | 4.43 × 10⁻¹⁰ |
| Bismuth iodide | BiI | 7.71 × 10⁻¹⁹ |
| Cadmium arsenate | Cd₃(AsO₄)₂ | 2.2 × 10⁻³³ |
| Cadmium carbonate | CdCO₃ | 1.0 × 10⁻¹² |
| Cadmium fluoride | CdF₂ | 6.44 × 10⁻³ |
| Cadmium hydroxide | Cd(OH)₂ | 7.2 × 10⁻¹⁵ |
| Cadmium iodate | Cd(IO₃)₂ | 2.5 × 10⁻⁸ |
| Cadmium oxalate trihydrate | CdC₂O₄×3H₂O | 1.42 × 10⁻⁸ |
| Cadmium phosphate | Cd₃(PO₄)₂ | 2.53 × 10⁻³³ |
| Cadmium sulfide | CdS | 1 × 10⁻²⁷ |
| Cesium perchlorate | CsClO₄ | 3.95 × 10⁻³ |
| Cesium periodate | CsIO₄ | 5.16 × 10⁻⁶ |
| Calcium carbonate (calcite) | CaCO₃ | 3.36 × 10⁻⁹ |
| Calcium carbonate (aragonite) | CaCO₃ | 6.0 × 10⁻⁹ |
| Calcium fluoride | CaF₂ | 3.45 × 10⁻¹¹ |
| Calcium hydroxide | Ca(OH)₂ | 5.02 × 10⁻⁶ |
| Calcium iodate | Ca(IO₃)₂ | 6.47 × 10⁻⁶ |
| Calcium iodate hexahydrate | Ca(IO₃)₂×6H₂O | 7.10 × 10⁻⁷ |
| Calcium molybdate | CaMoO | 1.46 × 10⁻⁸ |
| Calcium oxalate monohydrate | CaC₂O₄×H₂O | 2.32 × 10⁻⁹ |
| Calcium phosphate | Ca₃(PO₄)₂ | 2.07 × 10⁻³³ |
| Calcium sulfate | CaSO₄ | 4.93 × 10⁻⁵ |
| Calcium sulfate dihydrate | CaSO₄×2H₂O | 3.14 × 10⁻⁵ |
| Calcium sulfate hemihydrate | CaSO₄×0.5H₂O | 3.1 × 10⁻⁷ |
| Cobalt(II) arsenate | Co₃(AsO₄)₂ | 6.80 × 10⁻²⁹ |
| Cobalt(II) carbonate | CoCO₃ | 1.0 × 10⁻¹⁰ |
| Cobalt(II) hydroxide (blue) | Co(OH)₂ | 5.92 × 10⁻¹⁵ |
| Cobalt(II) iodate dihydrate | Co(IO₃)₂×2H₂O | 1.21 × 10⁻² |
| Cobalt(II) phosphate | Co₃(PO₄)₂ | 2.05 × 10⁻³⁵ |
| Cobalt(II) sulfide (alpha) | CoS | 5 × 10⁻²² |
| Cobalt(II) sulfide (beta) | CoS | 3 × 10⁻²⁶ |
| Copper(I) bromide | CuBr | 6.27 × 10⁻⁹ |
| Copper(I) chloride | CuCl | 1.72 × 10⁻⁷ |
| Copper(I) cyanide | CuCN | 3.47 × 10⁻²⁰ |
| Copper(I) hydroxide | Cu₂O | 2 × 10⁻¹⁵ |
| Copper(I) iodide | CuI | 1.27 × 10⁻¹² |
| Copper(I) thiocyanate | CuSCN | 1.77 × 10⁻¹³ |
| Copper(II) arsenate | Cu₃(AsO₄)₂ | 7.95 × 10⁻³⁶ |
| Copper(II) hydroxide | Cu(OH)₂ | 4.8 × 10⁻²⁰ |
| Copper(II) iodate monohydrate | Cu(IO₃)₂×H₂O | 6.94 × 10⁻⁸ |
| Copper(II) oxalate | CuC₂O₄ | 4.43 × 10⁻¹⁰ |
| Copper(II) phosphate | Cu₃(PO₄)₂ | 1.40 × 10⁻³⁷ |
| Copper(II) sulfide | CuS | 8 × 10⁻³⁷ |
| Europium(III) hydroxide | Eu(OH)₃ | 9.38 × 10⁻²⁷ |
| Gallium(III) hydroxide | Ga(OH)₃ | 7.28 × 10⁻³⁶ |
| Iron(II) carbonate | FeCO₃ | 3.13 × 10⁻¹¹ |
| Iron(II) fluoride | FeF₂ | 2.36 × 10⁻⁶ |
| Iron(II) hydroxide | Fe(OH)₂ | 4.87 × 10⁻¹⁷ |
| Iron(II) sulfide | FeS | 8 × 10⁻¹⁹ |
| Iron(III) hydroxide | Fe(OH)₃ | 2.79 × 10⁻³⁹ |
| Iron(III) phosphate dihydrate | FePO₄×2H₂O | 9.91 × 10⁻¹⁶ |
| Lanthanum iodate | La(IO₃)₃ | 7.50 × 10⁻¹² |
| Lead(II) bromide | PbBr₂ | 6.60 × 10⁻⁶ |
| Lead(II) carbonate | PbCO₃ | 7.40 × 10⁻¹⁴ |
| Lead(II) chloride | PbCl₂ | 1.70 × 10⁻⁵ |
| Lead(II) chromate | PbCrO₄ | 3 × 10⁻¹³ |
| Lead(II) fluoride | PbF₂ | 3.3 × 10⁻⁸ |
| Lead(II) hydroxide | Pb(OH)₂ | 1.43 × 10⁻²⁰ |
| Lead(II) iodate | Pb(IO₃)₂ | 3.69 × 10⁻¹³ |
| Lead(II) iodide | PbI₂ | 9.8 × 10⁻⁹ |
| Lead(II) oxalate | PbC₂O₄ | 8.5 × 10⁻⁹ |
| Lead(II) selenate | PbSeO₄ | 1.37 × 10⁻⁷ |
| Lead(II) sulfate | PbSO₄ | 2.53 × 10⁻⁸ |
| Lead(II) sulfide | PbS | 3 × 10⁻²⁸ |
| Lithium carbonate | Li₂CO₃ | 8.15 × 10⁻⁴ |
| Lithium fluoride | LiF | 1.84 × 10⁻³ |
| Lithium phosphate | Li₃PO₄ | 2.37 × 10⁻⁴ |
| Magnesium ammonium phosphate | MgNH₄PO₄ | 3 × 10⁻¹³ |
| Magnesium carbonate | MgCO₃ | 6.82 × 10⁻⁶ |
| Magnesium carbonate trihydrate | MgCO₃×3H₂O | 2.38 × 10⁻⁶ |
| Magnesium carbonate pentahydrate | MgCO₃×5H₂O | 3.79 × 10⁻⁶ |
| Magnesium fluoride | MgF₂ | 5.16 × 10⁻¹¹ |
| Magnesium hydroxide | Mg(OH)₂ | 5.61 × 10⁻¹² |
| Magnesium oxalate dihydrate | MgC₂O₄×2H₂O | 4.83 × 10⁻⁶ |
| Magnesium phosphate | Mg₃(PO₄)₂ | 1.04 × 10⁻²⁴ |
| Manganese(II) carbonate | MnCO₃ | 2.24 × 10⁻¹¹ |
| Manganese(II) iodate | Mn(IO₃)₂ | 4.37 × 10⁻⁷ |
| Manganese(II) hydroxide | Mn(OH)₂ | 2 × 10⁻¹³ |
| Manganese(II) oxalate dihydrate | MnC₂O₄×2H₂O | 1.70 × 10⁻⁷ |
| Manganese(II) sulfide (pink) | MnS | 3 × 10⁻¹¹ |
| Manganese(II) sulfide (green) | MnS | 3 × 10⁻¹⁴ |
| Mercury(I) bromide | Hg₂Br₂ | 6.40 × 10⁻²³ |
| Mercury(I) carbonate | Hg₂CO₃ | 3.6 × 10⁻¹⁷ |
| Mercury(I) chloride | Hg₂Cl₂ | 1.43 × 10⁻¹⁸ |
| Mercury(I) fluoride | Hg₂F₂ | 3.10 × 10⁻⁶ |
| Mercury(I) iodide | Hg₂I₂ | 5.2 × 10⁻²⁹ |
| Mercury(I) oxalate | Hg₂C₂O₄ | 1.75 × 10⁻¹³ |
| Mercury(I) sulfate | Hg₂SO₄ | 6.5 × 10⁻⁷ |
| Mercury(I) thiocyanate | Hg₂(SCN)₂ | 3.2 × 10⁻²⁰ |
| Mercury(II) bromide | HgBr₂ | 6.2 × 10⁻²⁰ |
| Mercury(II) hydroxide | HgO | 3.6 × 10⁻²⁶ |
| Mercury(II) iodide | HgI₂ | 2.9 × 10⁻²⁹ |
| Mercury(II) sulfide (black) | HgS | 2 × 10⁻⁵³ |
| Mercury(II) sulfide (red) | HgS | 2 × 10⁻⁵⁴ |
| Neodymium carbonate | Nd₂(CO₃)₃ | 1.08 × 10⁻³³ |
| Nickel(II) carbonate | NiCO₃ | 1.42 × 10⁻⁷ |
| Nickel(II) hydroxide | Ni(OH)₂ | 5.48 × 10⁻¹⁶ |
| Nickel(II) iodate | Ni(IO₃)₂ | 4.71 × 10⁻⁵ |
| Nickel(II) phosphate | Ni₃(PO₄)₂ | 4.74 × 10⁻³² |
| Nickel(II) sulfide (alpha) | NiS | 4 × 10⁻²⁰ |
| Nickel(II) sulfide (beta) | NiS | 1.3 × 10⁻²⁵ |
| Palladium(II) thiocyanate | Pd(SCN)₂ | 4.39 × 10⁻²³ |
| Potassium hexachloroplatinate | K₂PtCl₆ | 7.48 × 10⁻⁶ |
| Potassium perchlorate | KClO₄ | 1.05 × 10⁻² |
| Potassium periodate | KIO₄ | 3.71 × 10⁻⁴ |
| Praseodymium hydroxide | Pr(OH)₃ | 3.39 × 10⁻²⁴ |
| Radium iodate | Ra(IO₃)₂ | 1.16 × 10⁻⁹ |
| Radium sulfate | RaSO₄ | 3.66 × 10⁻¹¹ |
| Rubidium perchlorate | RuClO₄ | 3.00 × 10⁻³ |
| Scandium fluoride | ScF₃ | 5.81 × 10⁻²⁴ |
| Scandium hydroxide | Sc(OH)₃ | 2.22 × 10⁻³¹ |
| Silver(I) acetate | AgCH₃COO | 1.94 × 10⁻³ |
| Silver(I) arsenate | Ag₃AsO₄ | 1.03 × 10⁻²² |
| Silver(I) bromate | AgBrO₃ | 5.38 × 10⁻⁵ |
| Silver(I) bromide | AgBr | 5.35 × 10⁻¹³ |
| Silver(I) carbonate | Ag₂CO₃ | 8.46 × 10⁻¹² |
| Silver(I) chloride | AgCl | 1.77 × 10⁻¹⁰ |
| Silver(I) chromate | Ag₂CrO₄ | 1.12 × 10⁻¹² |
| Silver(I) cyanide | AgCN | 5.97 × 10⁻¹⁷ |
| Silver(I) iodate | AgIO₃ | 3.17 × 10⁻⁸ |
| Silver(I) iodide | AgI | 8.52 × 10⁻¹⁷ |
| Silver(I) oxalate | Ag₂C₂O₄ | 5.40 × 10⁻¹² |
| Silver(I) phosphate | Ag₃PO₄ | 8.89 × 10⁻¹⁷ |
| Silver(I) sulfate | Ag₂SO₄ | 1.20 × 10⁻⁵ |
| Silver(I) sulfite | Ag₂SO₃ | 1.50 × 10⁻¹⁴ |
| Silver(I) sulfide | Ag₂S | 8 × 10⁻⁵¹ |
| Silver(I) thiocyanate | AgSCN | 1.03 × 10⁻¹² |
| Strontium arsenate | Sr₃(AsO₄)₂ | 4.29 × 10⁻¹⁹ |
| Strontium carbonate | SrCO₃ | 5.60 × 10⁻¹⁰ |
| Strontium fluoride | SrF₂ | 4.33 × 10⁻⁹ |
| Strontium iodate | Sr(IO₃)₂ | 1.14 × 10⁻⁷ |
| Strontium iodate monohydrate | Sr(IO₃)₂×H₂O | 3.77 × 10⁻⁷ |
| Strontium iodate hexahydrate | Sr(IO₃)₂×6H₂O | 4.55 × 10⁻⁷ |
| Strontium oxalate | SrC₂O₄ | 5 × 10⁻⁸ |
| Strontium sulfate | SrSO₄ | 3.44 × 10⁻⁷ |
| Thallium(I) bromate | TlBrO₃ | 1.10 × 10⁻⁴ |
| Thallium(I) bromide | TlBr | 3.71 × 10⁻⁶ |
| Thallium(I) chloride | TlCl | 1.86 × 10⁻⁴ |
| Thallium(I) chromate | Tl₂CrO₄ | 8.67 × 10⁻¹³ |
| Thallium(I) hydroxide | Tl(OH)₃ | 1.68 × 10⁻⁴⁴ |
| Thallium(I) iodate | TlIO₃ | 3.12 × 10⁻⁶ |
| Thallium(I) iodide | TlI | 5.54 × 10⁻⁸ |
| Thallium(I) thiocyanate | TlSCN | 1.57 × 10⁻⁴ |
| Thallium(I) sulfide | Tl₂S | 6 × 10⁻²² |
| Tin(II) hydroxide | Sn(OH)₂ | 5.45 × 10⁻²⁷ |
| Yttrium carbonate | Y₂(CO₃)₃ | 1.03 × 10⁻³¹ |
| Yttrium fluoride | YF₃ | 8.62 × 10⁻²¹ |
| Yttrium hydroxide | Y(OH)₃ | 1.00 × 10⁻²² |
| Yttrium iodate | Y(IO₃)₃ | 1.12 × 10⁻¹⁰ |
| Zinc arsenate | Zn₃(AsO₄)₂ | 2.8 × 10⁻²⁸ |
| Zinc carbonate | ZnCO₃ | 1.46 × 10⁻¹⁰ |
| Zinc carbonate monohydrate | ZnCO₃×H₂O | 5.42 × 10⁻¹¹ |
| Zinc fluoride | ZnF | 3.04 × 10⁻² |
| Zinc hydroxide | Zn(OH)₂ | 3 × 10⁻¹⁷ |
| Zinc iodate dihydrate | Zn(IO₃)₂×2H₂O | 4.1 × 10⁻⁶ |
| Zinc oxalate dihydrate | ZnC₂O₄×2H₂O | 1.38 × 10⁻⁹ |
| Zinc selenide | ZnSe | 3.6 × 10⁻²⁶ |
| Zinc selenite monohydrate | ZnSe×H₂O | 1.59 × 10⁻⁷ |
| Zinc sulfide (alpha) | ZnS | 2 × 10⁻²⁵ |
| Zinc sulfide (beta) | ZnS | 3 × 10⁻²³ |

Conventional descaling technologies include chemical and electromagnetic methods. Chemical methods utilize either pH adjustment, chemical sequestration with polyphosphates, zeolites and the like, or ionic exchange, and typically combinations of these methods. Normally, chemical methods aim at preventing scale from precipitating by lowering the pH and using chemical sequestration, but they are typically not 100% effective. Electromagnetic methods rely on the electromagnetic excitation of calcium or magnesium carbonate, so as to favor crystallographic forms that are non-adherent. For example, electromagnetic excitation favors the precipitation of aragonite rather than calcite, and the former is a softer, less adherent form of calcium carbonate. However, electromagnetic methods are only effective over relatively short distance and residence times. There is a need for permanently removing scale forming constituents from contaminated aqueous solutions, seawater or produce waters that are to be further processed.

Hydrocarbon contamination is another serious problem in aqueous systems, particularly if the concentration of such hydrocarbons exceed their solubilities in water and free-standing oil exists either as separate droplets or as a separate liquid phase, as is commonly the case with produce water—the water that comes mixed with gas and oil in industrial extraction operations. Ordinarily, oil that is present as a separate liquid phase is removed by a series of mechanical devices that utilize density difference as a means of separating oil from water, such as API separators, hydrocyclones, flotation cells, and the like. These technologies work reasonably well in eliminating the bulk of the oil, but they do little to the hydrocarbon fraction that remains in solution. Accordingly, even after mechanical treatment, produce water contains objectionable amounts of hydrocarbon contamination and is not potable. There is a need for permanently reducing the level of hydrocarbon contamination in aqueous systems.

Moreover, the growth in industrial activities since the industrial revolution has caused significant increases in the level of carbon dioxide (CO₂) in the atmosphere, and it is generally accepted that CO₂ increases are contributing to global warming. Many schemes for sequestering CO₂ are being proposed, such as deep-well injection, but such methods cannot guarantee the permanent sequestration of such green-house gas. There is a need for carbon sequestration methods that are cost-effective, permanent, and that yield chemical products that resist decomposition and are easily transported and stored.

### SUMMARY

Embodiments of the present invention provide an improved method of permanently removing hydrocarbons and hard water constituents from aqueous solutions by an integrated process that removes free-standing oil contaminants by mechanical means, then precipitates scale forming ions in the form of insoluble carbonates and subsequently precipitates other ions by heating. Because the composition of hard water varies by location, the precipitation step in the invention begins by adding stoichiometric amounts of either bicarbonate or divalent cations, such as calcium or magnesium, to form insoluble calcium or magnesium carbonate. Bicarbonate ions are added either through sparging the aqueous solution with carbon dioxide gas, or by adding bicarbonate ions directly in the form of sodium bicarbonate or other soluble bicarbonate chemicals. In alternate embodiments, hydroxide ions may be added (in the form of NaOH) to react in a similar manner with magnesium to form magnesium hydroxide. Calcium or magnesium ions may be added in the form of lime or equivalent alkaline compounds. The second step of precipitation in the process adjusts the pH of the aqueous solution to approximately 9.2 or greater, and preferably to the range of 10.2 to 10.5 or greater, in order to promote carbonate precipitation. The third step removes the precipitate formed in the previous step by either sedimentation or filtering. The fourth step consists of heating the aqueous solution to temperatures of the order of 120° C. for 5 to 10 minutes to promote the precipitation of insoluble sulfates and the like. The fifth step consists of removing the high-temperature precipitate by either sedimentation or filtering. A final step of degassing by steam stripping removes any remaining hydrocarbons in solution.

An embodiment of the present invention provides a method for removing scale forming compounds from tap water, contaminated aqueous solutions, seawater, and saline brines contaminated with hydrocarbons, such as produce water, comprising first the addition of carbonate ions by CO₂ sparging, or divalent cations, such as calcium or magnesium in stoichiometric amounts, so as to subsequently precipitate calcium and magnesium carbonates by adjusting pH to about 10.2 or greater, thus permanently sequestering CO₂ from the atmosphere, and then removing such precipitates by either sedimentation or filtering, and second a heat treatment step that raises the temperature of the aqueous solution to the range of 100° C. to 120° C. for 5 to 10 minutes to promote the further precipitation of insoluble sulfates and the like, and removes the scale by either filtration or sedimentation.

In a further aspect, calcium or magnesium additions are substituted for other divalent cations, such as barium, cadmium, cobalt, iron, lead, manganese, nickel, strontium, or zinc that have low solubility products in carbonate form.

In a further aspect, calcium or magnesium additions are substituted for trivalent cations, such as aluminum or neodymium, that have low solubility products in carbonate or hydroxide from.

In a further aspect, CO₂ sparging is replaced by the addition of soluble bicarbonate ions, such as sodium, potassium or ammonium bicarbonate.

In a further aspect, carbonate and scale precipitates are removed by means other than sedimentation or filtering, such as centrifuging.

In a further aspect, waste heat and heat pipes are utilized to transfer the heat and to raise the temperature of the aqueous solution.

In a further aspect, simultaneous removal of high-temperature scale, such as insoluble sulfates and carbonates, with the degassing of VOCs, gases, and non-volatile organic compounds to levels below 10 ppm, is achieved.

In a further aspect, the permanent sequestration of CO₂ from the atmosphere is achieved in conventional desalination systems, such as multiple stage flash (MSF) evaporation, multiple effect distillation (MED) plants, and vapor compression (VC) desalination systems

In a further aspect, scale-forming salts are permanently removed from conventional desalination systems.

In a further aspect, objectionable hydrocarbons and scale are removed from produce water from both, oil and gas extraction operations.

In a further aspect, tap water, municipal water, or well water containing objectionable hard water constituents, such as calcium or magnesium, are descaled in residential water purification systems.

In a further aspect, heat pipes are used to recover heat in descaling and hydrocarbon removal operations.

In a further aspect, valuable scale-forming salts, such as magnesium, barium, and other salts, are recovered.

In a further aspect, scale-forming compounds are precipitated in the form of non-adhering, easily filterable or sedimentable solids and ultimately removed.

In a further aspect, waste heat is utilized from existing power plants, and CO₂ emissions from such plants are permanently sequestered.

In a further aspect, oxygen and dissolved air are removed from seawater and produce water streams prior to further processing, so as to reduce corrosion and maintenance problems.

In a further aspect, scale forming compounds are sequentially precipitated and removed, so they can be utilized and reused in downstream industrial processes.

A further embodiment of the present invention provides a method for removing a scale forming compound from an aqueous solution, comprising: adding at least one ion to the solution in a stoichiometric amount sufficient to cause the precipitation of a first scale forming compound at an alkaline pH; adjusting the pH of the solution to an alkaline pH, thereby precipitating the first scale forming compound; removing the first scale forming compound from the solution; heating the solution to a temperature sufficient to cause the precipitation of a second scale forming compound from the solution; and removing the second scale forming compound from the solution.

In a further aspect, the ion is selected from the group consisting of carbonate ions and divalent cations. In a further aspect, the carbonate ion is HCO₃⁻. In a further aspect, the divalent cation is selected from the group consisting of Ca²⁺ and Mg²⁺.

In a further aspect, the stoichiometric amount is sufficient to substitute the divalent cation for a divalent cation selected from the group consisting of barium, cadmium, cobalt, iron, lead, manganese, nickel, strontium, and zinc in the first scale forming compound.

In a further aspect, the stoichiometric amount is sufficient to substitute the divalent cation for a trivalent cation selected from the group consisting of aluminum and neodymium in the first scale forming compound.

In a further aspect, adding at least one ion comprises sparging the solution with CO₂ gas.

In a further aspect, the CO₂ is atmospheric CO₂.

In a further aspect, adding at least one ion comprises adding a soluble bicarbonate ion selected from the group consisting of sodium bicarbonate, potassium bicarbonate, and ammonium bicarbonate to the solution.

In a further aspect, adding at least one ion comprises adding a compound selected from the group consisting of CaO, Ca(OH)₂, Mg(OH)₂, and MgO to the solution.

In a further aspect, the alkaline pH is a pH of approximately 9.2 or greater.

In a further aspect, the first scale forming compound is selected from the group consisting of CaCO₃ and MgCO₃.

In a further aspect, adjusting the pH of the solution comprises adding a compound selected from the group consisting of CaO and NaOH to the solution.

In a further aspect, removing the first scale forming compound comprises at least one of filtration, sedimentation, and centrifuging.

In a further aspect, the temperature is within a range of approximately 100° C. to approximately 120° C.

In a further aspect, waste heat from a power plant or similar industrial process is used to accomplish heating of the solution.

In a further aspect, the temperature is maintained within the range for a period of from approximately 5 to approximately 10 minutes.

In a further aspect, the second scale forming compound comprises a sulfate compound.

In a further aspect, removing the second scale forming compound comprises at least one of filtration, sedimentation, and centrifuging.

In a further aspect, heating the solution additionally comprises bringing the solution into contact with steam, whereby the degassing of volatile organic constituents (“VOCs”), gases, and non-volatile organic compounds to levels below 10 ppm from the solution is accomplished.

In a further aspect, contaminants are removed from the solution, prior to adding at least one ion, removing contaminants from the solution.

In a further aspect, the contaminants are selected from the group consisting of solid particles and hydrocarbon droplets.

In a further aspect, the aqueous solution is selected from the group consisting of tap water, contaminated aqueous solutions, seawater, and saline brines contaminated with hydrocarbons.

In a further aspect, after the second scale forming compound is removed, the aqueous solution is degassed, wherein the degassing is adapted to remove a hydrocarbon compound from the aqueous solution.

A further embodiment of the present invention provides a method of obtaining scale forming compounds, comprising: providing an aqueous solution; adding at least one ion to the solution in a stoichiometric amount sufficient to cause the precipitation of a first scale forming compound at an alkaline pH; adjusting the pH of the solution to an alkaline pH, thereby precipitating the first scale forming compound; removing the first scale forming compound from the solution; heating the solution to a temperature sufficient to cause the precipitation of a second scale forming compound from the solution; removing the second scale forming compound from the solution; recovering the first scale forming compound; and recovering the second scale forming compound.

In a further aspect, the first and second scale forming compounds are selected from the group of compounds listed in Table 1.

A further embodiment of the present invention provides a method of sequestering atmospheric CO₂, comprising: providing an aqueous solution containing at least one ion capable of forming a CO₂-sequestering compound in the presence of carbonate ion; adding carbonate ion to the solution in a stoichiometric amount sufficient to cause the precipitation of the CO₂-sequestering compound at an alkaline pH; adjusting the pH of the solution to an alkaline pH, thereby precipitating the CO₂-sequestering compound; and removing the CO₂-sequestering compound from the solution; wherein adding carbonate ion comprises adding atmospheric CO₂ to the solution, and wherein the atmospheric CO₂ is sequestered in the CO₂-sequestering compound.

In a further aspect, the aqueous solution is selected from the group consisting of contaminated aqueous solutions, seawater, and saline brines contaminated with hydrocarbons.

In a further aspect, the alkaline pH is a pH of approximately 9.2 or greater.

In a further aspect, the CO₂-sequestering compound is selected from the group consisting of CaCO₃ and MgCO₃.

In a further aspect, removing the CO₂-sequestering compound comprises at least one of filtration, sedimentation, and centrifuging.

A further embodiment of the present invention provides an apparatus for removing a scale forming compound from an aqueous solution, comprising: an inlet for the aqueous solution; a source of CO₂ gas; a first tank in fluid communication with the inlet and the source of CO₂ gas; a source of a pH-raising agent; a second tank in fluid communication with the source of the pH-raising agent and the first tank; a filter in fluid communication with said second tank, wherein the filter is adapted to separate a first scale forming compound from the solution in said second tank; a pressure vessel in fluid communication with said filter and adapted to heat the solution within said pressure vessel to a temperature within a range of approximately 100° C. to approximately 120° C.; and a filter in fluid communication with said pressure vessel, wherein the filter is adapted to separate a second scale forming compound from the solution in the pressure vessel.

In a further aspect, the apparatus additionally comprises a deoiler in fluid communication with the inlet and the first tank, wherein the deoiler is adapted to remove a contaminant selected from the group consisting of solid particles and hydrocarbon droplets from the solution.

In a further aspect, the apparatus additionally comprises a degasser downstream of and in fluid communication with the pressure vessel, wherein the degasser is adapted to remove a hydrocarbon compound from the solution.

A further embodiment of the present invention provides an apparatus for sequestering atmospheric CO₂ in a CO₂-sequestering compound, comprising an inlet for an aqueous solution containing at least one ion capable of forming a CO₂-sequestering compound in the presence of carbonate ion; a source of atmospheric CO₂ gas; a first tank in fluid communication with the inlet and the source of CO₂ gas; a source of a pH-raising agent; a second tank in fluid communication with the source of the pH-raising agent and the first tank; and a filter in fluid communication with said second tank, wherein the filter is adapted to separate the CO₂-sequestering compound from the solution in said second tank.

In a further aspect, the apparatus additionally comprises a deoiler in fluid communication with the inlet and the first tank, wherein the deoiler is adapted to remove a contaminant selected from the group consisting of solid particles and hydrocarbon droplets from the solution.

### BRIEF DESCRIPTION OF THE DRAWINGS

FIG. 1 is a diagram of an apparatus adapted to carry out an integrated pre-treatment method.

FIG. 2 is a diagram of a deoiler.

FIG. 3 is a chart showing the relationship between pH and the concentration of carbonic acid, bicarbonate ion, and carbonate ion in an aqueous solution.

FIG. 4 is a diagram of an alternative degasser-precipitator.

FIG. 5 is an illustration of the descaling method applied to a residential water purification system.

### DETAILED DESCRIPTION

Embodiments of the invention are disclosed herein, in some cases in exemplary form or by reference to one or more Figures. However, any such disclosure of a particular embodiment is exemplary only, and is not indicative of the full scope of the invention.

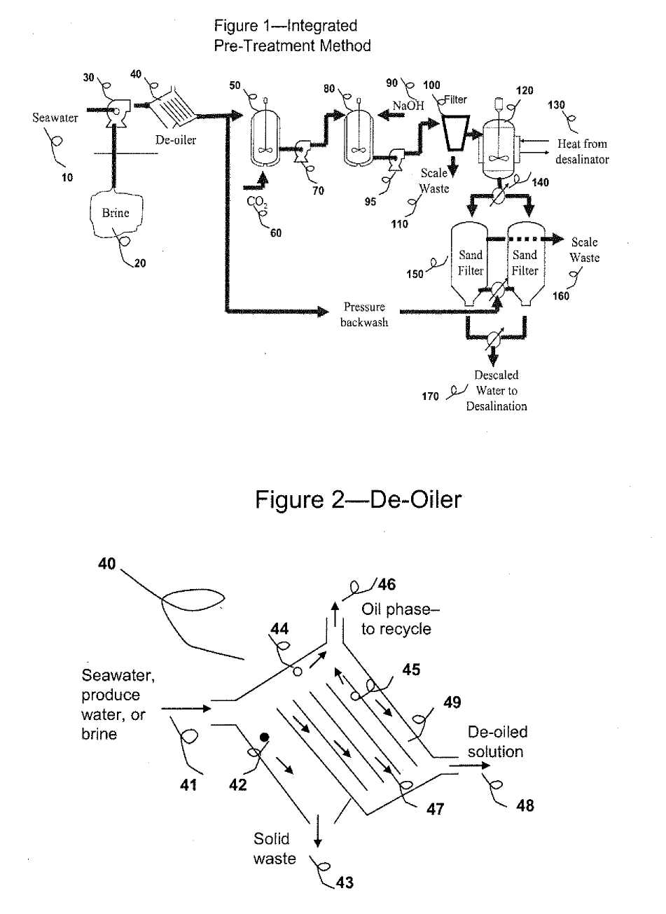

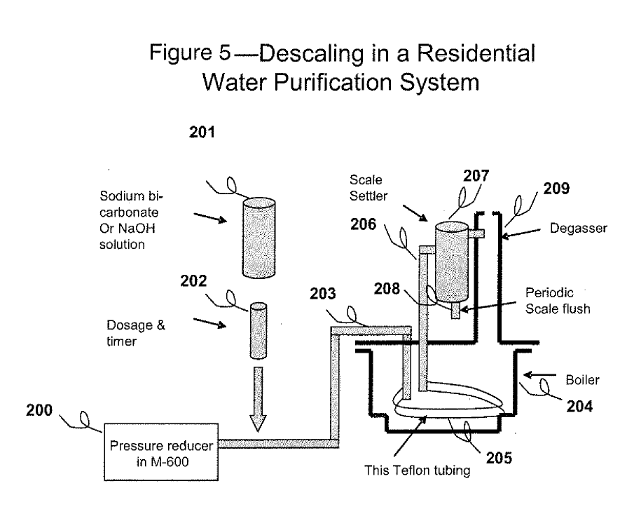

The following discussion makes reference to structural features of an exemplary descaling and pre-treatment method for contaminated aqueous solutions according to embodiments of the invention. Reference numerals correspond to those depicted in FIGS. 1-5.

Seawater (10) or saline aquifer water (20) containing hydrocarbons and other contaminants are pumped to the incoming feed intake of the pre-treatment system by pump (30). The contaminated feedwater is first treated in a deoiler (40) that removes solid particles (42), such as sand and other solid debris, as well as visible oil in the from of oil droplets (44), so as to provide an aqueous product (48) that is essentially free of visible oil. The deoiler (40) operates on the basis of density difference. Incoming contaminated water (41) enters the deoiler (40) through an enlarged aperture that greatly reduces flow velocity, so as to allow solid particles (42) to settle out of suspension and exit the de-oiler through a solid waste duct (43). Once solids have been eliminated, the contaminated stream enters several inclined settling channels (49) where flow (47) is laminar and sufficiently slow to allow oil droplets (44) and (45) to coalesce and raise through the channel flow until they exit near the top (46) of the deoiler. The de-oiled stream exists near the bottom (48) of the deoiler.

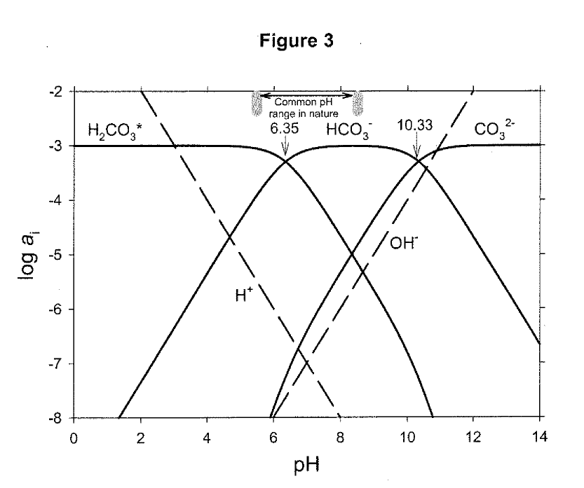

The de-oiled seawater or contaminated brine then begins the process of de-scaling. The fundamental principle in the proposed descaling method is to promote the precipitation of scale-forming compounds as insoluble carbonates. For this purpose, it is useful to consider the activity coefficients of carbonic acid (H₂CO₃), bicarbonate ion (HCO₃—), and carbonate ion (CO₃²⁻) as a function of pH, as illustrated by FIG. 3. At pH values below 6.0, the predominant species is carbonic acid. At pH values between 6.0 and 10.0, bicarbonate ion predominates, and at pH values above 10.3, carbonate ions are the predominant species. The method proposed consists of providing the necessary amount of carbon dioxide, such that upon pH adjustment to 9.2 and above, more preferably 10.2 and above, the bivalent cations and particularly the calcium (Ca²⁺) and magnesium (Mg²⁺) ions present in the contaminated solution will precipitate as insoluble carbonates.

Most saline brines, including seawater, contain calcium and magnesium ions in excess of bicarbonate ion. Accordingly, most saline brines require additional carbonate ions for precipitating scale forming constituents, and the most practical method of providing carbonate ions is in the form of CO₂ that is dissolved as bicarbonate ion; upon alkaline pH adjustment, such bicarbonate ions turn into carbonate, which immediately precipitate as calcium or magnesium in accordance with their solubility products. The use of atmospheric CO₂ provides a permanent way of effecting sequestration of this harmful green-house gas.

However, some brines contain an excess of bicarbonate ions, particularly those associated with produce water in oil or gas fields that traverse trona deposits. In those cases where bicarbonate ions appear in excess, the brine composition can be adjusted with lime (CaO), which serves the dual purpose of providing bivalent ions and increasing the pH to the alkaline range.

Referring back to FIGS. 1 to 5, once the incoming contaminated water has been de-oiled, it goes into a stirred tank or static mixer (50) where CO₂ gas (60) is sparged to provide for the stoichiometric amounts of carbonate ions so as to effect an initial precipitation of calcium and magnesium ions as insoluble carbonates. The carbonated solution is then pumped into another stirred tank reactor or static mixer (80) by means of pump (70), and pH is adjusted in reactor (80) by means of a pH-additions of lime (CaO), lye (Na[OH]), or both, but preferably with sodium hydroxide. Upon pH adjustment to the alkaline side, but preferably to pH higher than 10.2, the saline or contaminated solution will show the immediate precipitation of insoluble carbonates (110) and the like, which are then filtered or sedimented out of the process water by either belt, disk or drum filters (100), or counter-current decantation (CCD) vessels, or thickeners.

Following the initial precipitation of scale by pH adjustment and the removal of such scale by sedimentation or filtering, the clear solution enters a stirred reactor (120) where a second scale precipitation step takes place by heating. Heat from an external heat source (130), which can be waste steam from a power plant, or heat transferred by heat pipes from an industrial plant, is used to heat reactor (120) to temperatures of about 120° C., which requires a pressure vessel able to operate at overpressures of the order of 15 psig. Under such conditions, certain insoluble sulfates, such as calcium sulfate (gypsum), precipitate because their solubility in water markedly decreases.

A discussion of heat pipes for transferring heat from condensing steam to inlet water is provided in U.S. patent application Ser. No. 12/090,248, entitled ENERGY-EFFICIENT DISTILLATION SYSTEM, filed Apr. 14, 2008, and U.S. Provisional Patent Application No. 60/727,106, entitled ENERGY-EFFICIENT DISTILLATION SYSTEM, filed Oct. 14, 2005, both of which are incorporated herein by reference in their entirety.

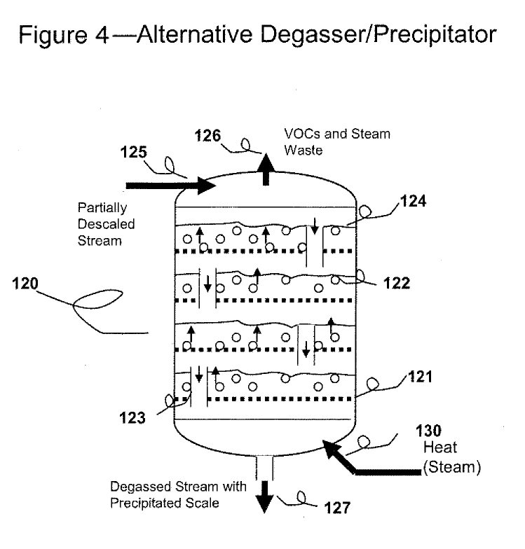

In an alternative embodiment, this second precipitation step is accomplished in a dual step that includes degassing by steam stripping. By reference to FIG. 4, the partially descaled process stream (125) enters a distillation tray column where it cascades through a series of sparging trays (121). Steam from a waste heat source (130), such as waste steam from a power plant, enters vessel (120) at the bottom at bubbles (122) through each distillation tray (121) in a counter-current fashion, thereby stripping volatile organic constituents (VOCs) from the process water, and simultaneously heating the process stream to temperatures of the order of 120° C., thereby precipitating insoluble salts that exhibit reduced solubility, such as certain sulfates. The liquid level in each steam stripping tray (121) is maintained by downcomer tubes (123) that transfer process water from an upper tray to a lower tray. As it rises through the degassing vessel, the steam becomes progressively loaded with organic contaminants, including contaminants that are considered non-volatile, and eventually exits the vessel at the top (126), so it can be condensed and discarded. The degassed stream containing the heat-precipitated scale exits the vessel at the bottom (127).

In a further alternative embodiment, a degassing process similar to the above is conducted as a final step after the aqueous solution has been heated and the second precipitate has been removed. This final degassing operates to remove any remaining hydrocarbon compounds, and is particularly appropriate when the aqueous solution treated is heavily contaminated with hydrocarbons, such as, for example, in the case of process water employed in oil production.

Next, the scale in the process water is filtered or sedimented out by means of either mechanical filters or thickeners. In a preferred embodiment, the process stream goes into dual sand filters (150) that alternate between filtering and a backwashing step by means of a mechanically actuated valve (140). The scale waste exits this filtering step at the top (160) and, depending on composition, can be either discarded or sold. The descaled and de-oiled process water (170) exits at the bottom, and can be used for any subsequent processing, such as desalination.

### Exemplary Water Descaling System for Seawater

The approximate chemical composition of seawater is presented in Table 2, below, and is typical of open ocean, but there are significant variations in seawater composition depending on geography and/or climate.

TABLE 2
Detailed composition of seawater
at 3.5% salinity

| Element | At. weight | ppm | Element | At. weight | ppm |
|---|---|---|---|---|---|
| Hydrogen H2O | 1.00797 | 110,000 | Molybdenum Mo | 0.09594 | 0.01 |
| Oxygen H2O | 15.9994 | 883,000 | Ruthenium Ru | 101.07 | 0.0000007 |
| Sodium NaCl | 22.9898 | 10,800 | Rhodium Rh | 102.905 | — |
| Chlorine NaCl | 35.453 | 19,400 | Palladium Pd | 106.4 | — |
| Magnesium Mg | 24.312 | 1,290 | Argentum (silver) Ag | 107.870 | 0.00028 |
| Sulfur S | 32.064 | 904 | Cadmium Cd | 112.4 | 0.00011 |
| Potassium K | 39.102 | 392 | Indium In | 114.82 | — |
| Calcium Ca | 10.08 | 411 | Stannum (tin) Sn | 118.69 | 0.00081 |
| Bromine Br | 79.909 | 67.3 | Antimony Sb | 121.75 | 0.00033 |
| Helium He | 4.0026 | 0.0000072 | Tellurium Te | 127.6 | — |
| Lithium Li | 6.939 | 0.170 | Iodine I | 166.904 | 0.064 |
| Beryllium Be | 9.0133 | 0.0000006 | Xenon Xe | 131.30 | 0.000047 |
| Boron B | 10.811 | 4.450 | Cesium Cs | 132.905 | 0.0003 |
| Carbon C | 12.011 | 28.0 | Barium Ba | 137.34 | 0.021 |
| Nitrogen ion | 14.007 | 15.5 | Lanthanum La | 138.91 | 0.0000029 |
| Fluorine F | 18.998 | 13 | Cerium Ce | 140.12 | 0.0000012 |
| Neon Ne | 20.183 | 0.00012 | Praesodymium Pr | 140.907 | 0.00000064 |
| Aluminum Al | 26.982 | 0.001 | Neodymium Nd | 144.24 | 0.0000028 |
| Silicon Si | 28.086 | 2.9 | Samarium Sm | 150.35 | 0.00000045 |
| Phosphorus P | 30.974 | 0.088 | Europium Eu | 151.96 | 0.0000013 |
| Argon Ar | 39.948 | 0.450 | Gadolinium Gd | 157.25 | 0.0000007 |
| Scandium Sc | 44.956 | <0.000004 | Terbium Tb | 158.924 | 0.00000014 |
| Titanium Ti | 47.90 | 0.001 | Dysprosium Dy | 162.50 | 0.00000091 |
| Vanadium V | 50.942 | 0.0019 | Holmium Ho | 164.930 | 0.00000022 |
| Chromium Cr | 51.996 | 0.0002 | Erbium Er | 167.26 | 0.00000087 |
| Manganese Mn | 54.938 | 0.0004 | Thulium Tm | 168.934 | 0.00000017 |
| Ferrum (Iron) Fe | 55.847 | 0.0034 | Ytterbium Yb | 173.04 | 0.00000082 |
| Cobalt Co | 58.933 | 0.00039 | Lutetium Lu | 174.97 | 0.00000015 |
| Nickel Ni | 58.71 | 0.0066 | Hafnium Hf | 178.49 | <0.000008 |
| Copper Cu | 63.54 | 0.0009 | Tantalum Ta | 180.948 | <0.0000025 |
| Zinc Zn | 65.37 | 0.005 | Tungsten W | 183.85 | <0.000001 |
| Gallium Ga | 69.72 | 0.00003 | Rhenium Re | 186.2 | 0.0000084 |
| Germanium Ge | 72.59 | 0.00006 | Osmium Os | 190.2 | — |
| Arsenic As | 74.922 | 0.0026 | Iridium Ir | 192.2 | — |
| Selenium Se | 78.96 | 0.0009 | Platinum Pt | 195.09 | — |
| Krypton Kr | 83.80 | 0.00021 | Aurum (gold) Au | 196.967 | 0.000011 |
| Rubidium Rb | 85.47 | 0.120 | Mercury Hg | 200.59 | 0.00015 |
| Strontium Sr | 87.62 | 8.1 | Thallium Tl | 204.37 | — |
| Yttrium Y | 88.905 | 0.000013 | Lead Pb | 207.19 | 0.00003 |
| Zirconium Zr | 91.22 | 0.000026 | Bismuth Bi | 208.980 | 0.00002 |
| Niobium Nb | 92.906 | 0.000015 | Thorium Th | 232.04 | 0.0000004 |
| | | | Uranium U | 238.03 | 0.0033 |
| | | | Plutonium Pu | (244) | — |

Note!
ppm = parts per million = mg/litre = 0.001 g/kg

Thus, the first task is to examine which salts exhibit the lowest solubility constants, limiting our examination to the most abundant elements in seawater. They are:

TABLE 3
Calcium compounds

| | | Solubility |
|---|---|---|
| | | Product |
| Calcium carbonate (calcite) | CaCO₃ | 3.36 × 10⁻⁹ |
| Calcium carbonate (aragonite) | CaCO₃ | 6.0 × 10⁻⁹ |
| Calcium fluoride | CaF₂ | 3.45 × 10⁻¹¹ |
| Calcium hydroxide | Ca(OH)₂ | 5.02 × 10⁻⁶ |
| Calcium iodate | Ca(IO₃)₂ | 6.47 × 10⁻⁶ |
| Calcium iodate hexahydrate | Ca(IO₃)₂×6H₂O | 7.10 × 10⁻⁷ |
| Calcium molybdate | CaMoO | 1.46 × 10⁻⁸ |
| Calcium oxalate monohydrate | CaC₂O₄×H₂O | 2.32 × 10⁻⁹ |
| Calcium phosphate | Ca₃(PO₄)₂ | 2.07 × 10⁻³³ |
| Calcium sulfate | CaSO₄ | 4.93 × 10⁻⁵ |
| Calcium sulfate dihydrate | CaSO₄×2H₂O | 3.14 × 10⁻⁵ |
| Calcium sulfate hemihydrate | CaSO₄×0.5H₂O | 3.1 × 10⁻⁷ |

Calcium ion concentration averages 416 ppm in seawater, or 10.4 mmol/lt, while bicarbonate ion represents 145 ppm, or 2.34 mmol/lt. Since bicarbonate easily decomposes into carbonate upon heating, calcite scale is the first scale that forms. Calcium sulfate (gypsum) is 10,000 times more soluble than calcite, so even though sulfate ion concentration averages 2701 ppm, or 28.1 mmol/lt, it precipitates next. Phosphorous amounts to 0.088 ppm, so the potential phosphate ion is sufficiently small to ignore the amount of phosphate scale.

TABLE 4
Magnesium Compounds

| | | Kₛₚ |
|---|---|---|
| Magnesium ammonium phosphate | MgNH₄PO₄ | 3 × 10⁻¹³ |
| Magnesium carbonate | MgCO₃ | 6.82 × 10⁻⁶ |
| Magnesium carbonate trihydrate | MgCO₃×3H₂O | 2.38 × 10⁻⁶ |
| Magnesium carbonate pentahydrate | MgCO₃ ×5H₂O | 3.79 × 10⁻⁶ |
| Magnesium fluoride | MgF₂ | 5.16 × 10⁻¹¹ |
| Magnesium hydroxide | Mg(OH)₂ | 5.61 × 10⁻¹² |
| Magnesium oxalate dihydrate | MgC₂O₄ ×2H₂O | 4.83 × 10⁻⁶ |
| Magnesium phosphate | Mg₃(PO₄)₂ | 1.04 × 10⁻²⁴ |

Magnesium is three times more abundant than calcium in seawater at 1,290 ppm (53.3 mmol/lt), but MgCO₃ is 1,000 times more soluble than its calcium counterpart, so it will precipitate after most of the calcium ions have been depleted. Fluoride ion is not present in sufficient quantities to cause significant scale, similar to the earlier discussion regarding phosphate scale formation. Similarly, although scale forming compounds are known that incorporate potassium, iron, or aluminum, as shown in Tables 5-7 below, in the case of seawater either these ions are present at such low concentrations that they do not precipitate, or if present in high amounts (as is the case, for example, for potassium), they are so soluble in aqueous solutions (i.e., have such high solubility constants) that they do not precipitate.

TABLE 5
Potassium compounds

| | | Kₛₚ |
|---|---|---|
| Potassium hexachloroplatinate | K₂PtCl₆ | 7.48 × 10⁻⁶ |
| Potassium perchlorate | KClO₄ | 1.05 × 10⁻² |
| Potassium periodate | KIO₄ | 3.71 × 10⁻⁴ |

TABLE 6
Iron compounds

| | | Kₛₚ |
|---|---|---|
| Iron(II) carbonate | FeCO₃ | 3.13 × 10⁻¹¹ |
| Iron(II) fluoride | FeF₂ | 2.36 × 10⁻⁶ |
| Iron(II) hydroxide | Fe(OH)₂ | 4.87 × 10⁻¹⁷ |
| Iron(II) sulfide | FeS | 8 × 10⁻¹⁹ |
| Iron(III) hydroxide | Fe(OH)₃ | 2.79 × 10⁻³⁹ |
| Iron(III) phosphate dihydrate | FePO₄ ×2H₂O | 9.91 × 10⁻¹⁶ |

TABLE 7
Aluminum compounds

| | | Kₛₚ |
|---|---|---|
| Aluminum hydroxide | Al(OH)₃ | 3 × 10⁻³⁴ |
| Aluminum phosphate | AlPO₄ | 9.84 × 10⁻²¹ |

The method and system of the present disclosure are used to purify both seawater and a solution that is more saline than seawater. The results show significant amelioration of the development of scale in the purification apparatus.

### Example 1

### Removal of Nonvolatile or Volatile Organics in Degasser

The method and system of the present disclosure are used to purify solutions containing commercially-observed amounts of nonvolatile and volatile organic contaminants, including methyl tertiary butyl ether (MTBE). The results show significant reduction in the amount of the contaminants as compared with conventional purification methods.

### Example 2

### Removal of Scale in Residential Water Purification Systems

In an alternative embodiment, the method of the invention can be used for softening hard waters from municipal systems, of from well waters containing high levels of calcium or magnesium salts.

Further information regarding residential water purification systems is provided in U.S. patent application Ser. Nos. 11/994,832, entitled WATER PURIFICATION SYSTEM, filed Jan. 4, 2008; 11/444,911, entitled FULLY AUTOMATED WATER PROCESSING CONTROL SYSTEM, filed May 31, 2006; 11/444,912, entitled AN IMPROVED SELF-CLEANING WATER PROCESSING APPARATUS, filed May 31, 2006; and 11/255,083, entitled WATER PURIFICATION SYSTEM, filed Oct. 19, 2005, and issued as U.S. Pat. No. 7,678,235, which are incorporated herein by reference in their entirety.

By reference to FIG. 4, tap water or water from a well enters the residential water purification system through a pressure reducer (200) that ensures constant flow of incoming water into the purification system. A canister (201) containing sodium hydroxide (lye-NaOH) and sodium bicarbonate (baking soda—NaHCO₃) provides a pre-measured amount of these chemicals to a dosage meter (202) to stoichiometrically precipitate up to 300 ppm of calcium and magnesium ions in the form of insoluble carbonates, while simultaneously raising the pH to values of at least 10.2. These chemicals dissolve in the tap water line (203) that exits the pressure reducer (200) and cause the precipitation of soft scale.

The partially descaled process water then enters boiler (204) by means of a plastic line (205 where the water is pre-heated by the boiling water in the boiler, and exists through a vertical tube (206) that connects to the upper part of a sedimentation vessel (207). Additional scale is precipitated by the pre-heating action which raises the temperature of the incoming water to just below boiling and thus promotes the precipitation of insoluble salts that show a marked decrease in solubility with temperature. The use of a plastic line or tube to effect pre-heating of the incoming water in the boiler subjects the plastic to frequent flexing by the boiling action, and thus prevents adherence of the scale to the surfaces of the pre-heating line.

The thermally precipitated scale plus the previously precipitated scale by pH adjustment settle by sedimentation in vessel (207), and are periodically flushed out of the vessel at the bottom (208). The descaled water then enters a degasser (209), where VOCs and non-volatile organic compounds are steam stripped by a counter-current flow of steam or hot air, as described in the aforementioned patent applications.

### Example 3

### Removal of Scale in Treatment of Waste Influent Compositions

An aqueous waste influent composition obtained as a waste stream from a fertilizer processing facility was treated in the manner described above in order to remove scale-forming compounds, as a pre-treatment to eventual purification of the product in a separate water purification apparatus in which the formation of scale would be highly undesirable. The throughput of the treatment apparatus was 6 gallons per day (GPD); this apparatus was used a pilot apparatus for testing an industrial situation requiring 2000 m³/day (528,401.6 GPD). The composition of the waste influent with respect to relevant elements and ions is given in Table 8 below.

TABLE 8
Waste Influent Composition

| | ppm |
|---|---|
| | (mg/l) |
| water analysis | |
| Barium | 0 |
| Calcium | 500 |
| Magnesium | 300 |
| Iron (III) | 2 |
| Bicarbonate | |
| Sulfate | 800 |
| Phosphate | 0 |
| Silica | 50 |
| Strontium | |
| Soluble salts | |
| Sodium | 700 |
| Potassium | 30 |
| Arsenic | 0 |
| Fluoride | 2 |
| Chloride | 1000 |
| Nitrate | 10 |

The waste influent had a total dissolved solids (TDS) content of 35,000 ppm (g/l). As can be seen from Table 8, the waste influent had particularly high concentrations of calcium and magnesium, which tend to give rise to scale.

This waste influent was processed in the manner described above; because the influent contained little or no hydrocarbons, deoiling and degassing were not conducted. In greater detail, CO₂ carbonation and addition of NaOH (to provide hydroxide ions to react with the Mg in solution) was followed by pH adjustment to a pH of 9.3 using further NaOH. The dosages of chemicals set forth in Table 9 below would be employed in the commercial-scale process (actual amounts employed were adjusted for a pilot throughput of 6 GPD).

TABLE 9
Chemicals employed
Chemicals Used

| | ton/day |
|---|---|
| CO₂ | 1.21 |
| NaOH for Mg | 2.17 |
| NaOH for pH | 0.12 |
| Total NaOH | 2.29 |

The process resulted in a filtered scale forming composition (“filter cake”) and an effluent (product). The mass balance of the commercial-scale process is shown in Table 10 below.

TABLE 10
Mass Balance
Mass Balance for Pre-treatment
Moisture in filter cake = 20.00%

| | metric | |
|---|---|---|
| | ton | s. ton |
| Waste (precipitate/filler) is | 4.59 | 5.05 |
| (tonne/ton) | | |

| | m³/d | GPD |
|---|---|---|
| Influent (Feedwater) flow is = | 2000 | 528401.6 |
| Amount of brine lost in filter cake | 0.89 | 236.44 |
| Effluent flow (product) | 1999.11 | 528165.15 |

The precipitate product obtained has the approximate composition shown in Table 11 below. The numbers shown in Table 11 for the commercial-scale process are based on the amounts produced in the pilot-scale process.

TABLE 11
Precipitate Composition

| | | | |
|---|---|---|---|
| 54.46% | of precipitate is CaCO₃ = | 2.50 mt/d, or | 2.75 ton/d |
| | of precipitate is | | |
| 45.36% | Mg(OH)₂ = | 2.08 mt/d, or | 2.29 ton/d |
| 0.18% | of precipitate is FeCO₃ = | 0.01 mt/d, or | 0.01 ton/d |
| 0.00% | of precipitate is SrCO₃ = | 0.00 mt/d, or | 0.00 ton/d |

| | |
|---|---|
| Total | 5.05 ton/d |
| precipitate is | |

As can be seen from Table 11, the overwhelming majority of the precipitate comprised either CaCO₃ or Mg(OH)₂, so that a large amount of the calcium and magnesium in the waste influent was removed by the process. The amounts of relevant elements and compounds contained in the feed waste solution and in the effluent product are summarized in Table 12 below.

TABLE 12
Composition of Solution Before and After Treatment
Water Analysis of Pre-treatment

| | Feed, ppm | Effluent, ppm |
|---|---|---|
| Barium | 0 | 0.00 |
| Calcium | 500 | 5.64 |
| Magnesium | 300 | 4.01 |
| Iron (III) | 2 | 0.00 |
| Bicarbonate | 0 | 0 |
| Sulfate | 800 | 800 |
| Phosphate | 0 | 0 |
| Silica | 50 | 50 |
| Strontium | 0 | 0.00 |
| Soluble salts | | |
| Sodium | 700 | 700 |
| Potassium | 30 | 30 |
| Arsenic | 0 | 0 |
| Fluoride | 2 | 2 |
| Chloride | 1000 | 1000 |
| Nitrate | 10 | 10 |
| TDS-calculated | 3394 | 2601.655 |
| TDS-Actual | 35,000 | 26829.09 |

The results shown in Table 12 indicate that the levels of elements giving rise to scale-forming compounds, such as calcium and magnesium, are reduced by up to approximately 99% by the treatment process described above. Additionally, the amount of iron was reduced to undetectable levels. Furthermore, the total dissolved solids in the aqueous solution were reduced by more than 20%.

### Example 4

### Removal of Scale in Treatment of Seawater

The treatment process of the present disclosure was applied to seawater that had been adjusted to a high level of TDS and a high degree of water hardness, to test the capacity of the process to deal with such input solutions. The water was pretreated using the process of the present disclosure, before being purified in a water purification apparatus such as that described in U.S. Pat. No. 7,678,235. As discussed in greater detail below, the seawater subjected to the pretreatment process of the present disclosure showed no formation of scale when used as feed water in the water purification apparatus.

The following amounts of various compounds were added to fresh ocean water, to produce the input aqueous solution of the present example. 7 grams/liter Ca(OH)₂ were added to produce a target Ca²⁺ concentration of 7.1 kppm. 29 grams/liter of NaCl were also added, and the TDS of the resulting water sample was 66 kppm.

A first precipitation was conducted at room temperature by adding approximately 12 grams/liter of NaHCO₃, and NaOH as necessary to increase the pH of the solution to greater than 10.5. The carbonate compounds CaCO₃ and MgCO₃ were precipitated in this first room temperature procedure. The water was filtered to remove the solid precipitates.

A second precipitation was then conducted at an elevated temperature. Specifically, the filtered water was heated to 120° C. for a period of 10-15 minutes. As a result, sulfates, primarily CaSO₄ and MgSO₄, were precipitated. The water was allowed to cool, then filtered to remove the precipitates. The descaled and filtered water was checked again for precipitates by boiling a sample in a microwave oven. No precipitates were observed in this test The TDS of the descaled and filtered water was approximately 66 kppm.

The descaled water was used as an influent for a water purification apparatus in accordance with U.S. Pat. No. 7,678,235. The product water was collected from the apparatus, and the TDS of the product water was measured. While the inlet water had a TDS of 66 kppm, the product water of the water purification apparatus was less than 10 ppm. No appreciable development of scale was observed in the boiler of the apparatus.

In some embodiments, the system for descaling water and saline solutions, embodiments of which are disclosed herein, can be combined with other systems and devices to provide further beneficial features. For example, the system can be used in conjunction with any of the devices or methods disclosed in U.S. Provisional Patent Application No. 60/676,870 entitled, SOLAR ALIGNMENT DEVICE, filed May 2, 2005; U.S. Provisional Patent Application No. 60/697,104 entitled, VISUAL WATER FLOW INDICATOR, filed Jul. 6, 2005; U.S. Provisional Patent Application No. 60/697,106 entitled, APPARATUS FOR RESTORING THE MINERAL CONTENT OF DRINKING WATER, filed Jul. 6, 2005; U.S. Provisional Patent Application No. 60/697,107 entitled, IMPROVED CYCLONE DEMISTER, filed Jul. 6, 2005; PCT Application No: US2004/039993, filed Dec. 1, 2004; PCT Application No: US2004/039991, filed Dec. 1, 2004; PCT Application No: US2006/040103, filed Oct. 13, 2006, U.S. patent application No, 12/281,608, filed Sep. 3, 2008, PCT Application No. US2008/03744, filed Mar. 21, 2008, and U.S. Provisional Patent Application No. 60/526,580, filed Dec. 2, 2003; each of the foregoing applications is hereby incorporated by reference in its entirety.

One skilled in the art will appreciate that these methods and devices are and may be adapted to carry out the objects and obtain the ends and advantages mentioned, as well as various other advantages and benefits. The methods, procedures, and devices described herein are presently representative of preferred embodiments and are exemplary and are not intended as limitations on the scope of the invention. Changes therein and other uses will occur to those skilled in the art which are encompassed within the spirit of the invention and are defined by the scope of the disclosure.

It will be apparent to one skilled in the art that varying substitutions and modifications can be made to the invention disclosed herein without departing from the scope and spirit of the invention.

Those skilled in the art recognize that the aspects and embodiments of the invention set forth herein can be practiced separate from each other or in conjunction with each other. Therefore, combinations of separate embodiments are within the scope of the invention as disclosed herein.

All patents and publications are herein incorporated by reference to the same extent as if each individual publication was specifically and individually indicated to be incorporated by reference.

The invention illustratively described herein suitably can be practiced in the absence of any element or elements, limitation or limitations which is not specifically disclosed herein. The terms and expressions which have been employed are used as terms of description and not of limitation, and there is no intention that in the use of such terms and expressions indicates the exclusion of equivalents of the features shown and described or portions thereof. It is recognized that various modifications are possible within the scope of the invention disclosed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the disclosure.

1. A method of removing a scale forming compound from an aqueous solution, comprising:
adding at least one ion to the solution in a stoichiometric amount sufficient to cause the precipitation of a first scale forming compound at an alkaline pH;
adjusting the pH of the solution to an alkaline pH, thereby precipitating the first scale forming compound;
removing the first scale forming compound from the solution;
heating the solution to a temperature sufficient to cause the precipitation of a second scale forming compound from the solution; and
removing the second scale forming compound from the solution.

2. The method of claim 1, wherein the ion is selected from the group consisting of carbonate ions and divalent cations.

3-4. (canceled)

5. The method of claim 1, wherein the stoichiometric amount is sufficient to substitute the divalent cation for a divalent cation selected from the group consisting of barium, cadmium, cobalt, iron, lead, manganese, nickel, strontium, and zinc in the first scale forming compound.

6. The method of claim 1, wherein the stoichiometric amount is sufficient to substitute the divalent cation for a trivalent cation selected from the group consisting of aluminum and neodymium in the first scale forming compound.

7. The method of claim 1, wherein adding at least one ion comprises sparging the solution with CO₂ gas.

8. The method of claim 7, wherein the CO₂ is atmospheric CO₂.

9-13. (canceled)

14. The method of claim 1, wherein removing the first scale forming compound comprises at least one step selected from the group consisting of filtration, sedimentation, and centrifuging.

15. (canceled)

16. The method of claim 1, wherein waste heat from a power plant or similar industrial process is used to accomplish heating of the solution.

17-18. (canceled)

19. The method of claim 1, wherein removing the second scale forming compound comprises at least one step selected from the group consisting of filtration, sedimentation, and centrifuging.

20. The method of claim 1, wherein heating the solution additionally comprises bringing the solution into contact with steam, whereby the degassing of volatile organic constituents (“VOCs”), gases, and non-volatile organic compounds to levels below 10 ppm from the solution is accomplished.

21. The method of claim 1, additionally comprising, prior to adding at least one ion, removing contaminants from the solution.

22-23. (canceled)

24. The method of claim 1, additionally comprising, after removing the second scale forming compound, degassing the aqueous solution, wherein the degassing is adapted to remove a hydrocarbon compound from the aqueous solution.

25-26. (canceled)

27. A method of sequestering atmospheric CO₂, comprising:
providing an aqueous solution containing at least one ion capable of forming a CO₂-sequestering compound in the presence of carbonate ion;
adding carbonate ion to the solution in a stoichiometric amount sufficient to cause the precipitation of the CO₂-sequestering compound at an alkaline pH;
adjusting the pH of the solution to an alkaline pH, thereby precipitating the CO₂-sequestering compound; and
removing the CO₂-sequestering compound from the solution;
wherein adding carbonate ion comprises adding atmospheric CO₂ to the solution, and wherein the atmospheric CO₂ is sequestered in the CO₂-sequestering compound.

28-29. (canceled)

30. The method of claim 27, wherein the CO₂-sequestering compound is selected from the group consisting of CaCO₃ and MgCO₃.

31. The method of claim 27, wherein removing the CO₂-sequestering compound comprises at least one step selected from the group consisting of filtration, sedimentation, and centrifuging.

32. An apparatus for removing a scale forming compound from an aqueous solution, comprising:
an inlet for the aqueous solution;
a source of CO₂ gas;
a first tank in fluid communication with the inlet and the source of CO₂ gas;
a source of a pH-raising agent;
a second tank in fluid communication with the source of the pH-raising agent and the first tank;
a filter in fluid communication with said second tank, wherein the filter is adapted to separate a first scale forming compound from the solution in said second tank;
a pressure vessel in fluid communication with said filter and adapted to heat the solution within said pressure vessel to a temperature within a range of approximately 100° C. to approximately 120° C.; and
a filter in fluid communication with said pressure vessel, wherein the filter is adapted to separate a second scale forming compound from the solution in the pressure vessel.

33. The apparatus of claim 32, further comprising:
a deoiler in fluid communication with the inlet and the first tank, wherein the deoiler is adapted to remove a contaminant selected from the group consisting of solid particles and hydrocarbon droplets from the solution.

34. The apparatus of claim 32, further comprising:
a degasser downstream of and in fluid communication with the pressure vessel, wherein the degasser is adapted to remove a hydrocarbon compound from the solution.

35-36. (canceled)
